(19) United States
(12) Patent Application Publication
(10) Pub. No.: US 2003/0171996 A1
(43) Pub. Date: Sep. 11, 2003

(54) Method for delivery of products purchased online

(76) Inventors: Andy Chen, Valiada, CA (US); Jackson Lan, Hacienda Heights, CA (US); Andy Chiang, Pomona, CA (US); Howard Tsao, Rowland Heights, CA (US); Andrew Lin, Diamond Bar, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/094,078

(22) Filed: Mar. 7, 2002

(51) Int. Cl. G06F 17/60

(52) U.S. Cl. 705/26

(57) ABSTRACT

A method that enables customers who purchase online on the Internet to select either pickup or receipt of products at designated locations. The method comprises receiving a customer's order from an online store (1) via an electronic communications network (10), and providing a list of shops from which the customer can select the nearest shop to him for pickup of products. A plurality of shop inventory management systems (2a-2n) is provided to manage shop inventory information. Such information can be accessed on the online store via the network. A distribution center inventory management system (3) is provided to manage distribution center inventory information. Such information can also be accessed on the online store via the network, to see if the products ordered are available. The method further provides a function of automatically adjusting the inventory of the ordered products according to the customer's order when the customer's order is accepted.

### BACKGROUND OF THE INVENTION

1. Field of the Invention

This invention relates to delivery of products to customers who purchase online on the Internet, and more particularly to methods that enable customers to select pickup of products at designated locations or receipt of products at designated locations.

2. Description of Related Art

As web communications technology has advanced, more and more enterprises are beginning to conduct business on the Internet to reduce operating costs and improve efficiency. In web sales transactions, operating costs for delivery of products are still significant. An enterprise needs a highly efficient system of delivery of products in an increasingly competitive web sales market.

Conventionally, an enterprise conducting sales on the Internet has a web portal such as an online store for receiving purchase orders, and a distribution center for distributing ordered products to customers. Once a customer's order is accepted, the ordered products are shipped from the distribution center to a place designated in the customer's order. However, particularly with retail purchases made online, a customer is frequently located far away from the distribution center. Such customer does not receive the ordered products for a long time. Three to six weeks' waiting time is commonplace. If such customer requests special fast delivery, for example within one or two days after payment, an expensive surcharge is usually levied. Fast delivery normally means extra charges.

Additionally, when a particular product is in great demand, customers' orders are frequently delayed or even rejected due to lack of inventory in the distribution center. However, conventional means for tracking and updating inventory cannot keep pace with online orders. As a result, purported real time inventory status displayed in the online store is often inaccurate. A customer may order products from the online store that are in fact unavailable in the distribution center. This results in delays and inconvenience for the customer.

Furthermore, after a customer has placed an order with an online store, tracking of subsequent processing of the order is problematic. Generally, an online retail store does not provide customers with means for tracking the processing of orders made.

Accordingly, what is needed is a method that enables customers to speedily and inexpensively pick up or receive products ordered online. What is also needed is a system and method that enables customers to conveniently track subsequent processing of online purchases made.

### SUMMARY OF THE INVENTION

A primary object of the present invention is to provide a method that enables customers who purchase online on the Internet to select pickup of products from designated locations or receipt of products at designated locations.

Another object of the present invention is to provide a method of ensuring that a customer need only travel the shortest distance possible to collect products ordered online.

A further object of the present invention is to provide a method of enabling customers to track subsequent processing of purchases made online.

The present invention achieves the above objects and solves the foregoing problems by providing a method for delivery of products purchased online.

The method is implemented in an online purchase environment which comprises an online store for receiving customers' orders, a plurality of shops located in different areas for pickup of products, and a distribution center for storing products and distributing products to each shop and to customers. In one aspect of the present invention, the method comprises the steps of: receiving a customer's order from the online store via a communications network, the customer's order including purchase, billing, shipping and contact information; providing a selection of shipping options for the customer, the shipping options including a first option of shipping to one of the shops and a second option of shipping directly to the customer; checking inventory to ascertain whether the products ordered in the customer's order are available; accepting the customer's order when the ordered products are available; and shipping the ordered products according to the shipping option selected by the customer.

In another aspect of the present invention, the method comprises the steps of: receiving a customer's order from the online store via a communications network, the customer's order including purchase, billing, shipping and contact information; providing online a selection of shops from which the customer may select one shop for pickup of the ordered products; checking inventory to ascertain whether the products ordered in the customer's order are available; accepting the customer's order when the ordered products are available; and shipping the ordered products according to the shop selected by the customer for pickup.

These and other objects, features, and advantages of the present invention will become more fully apparent from the following description and appended claims, or may be learned by practice of the invention as set forth hereinafter.

### BRIEF DESCRIPTION OF THE DRAWINGS

The invention will be described and explained with additional specificity and detail in conjunction with the accompanying drawings, in which:

FIG. 1 is a flow chart illustrating a method of checkout processing of online transactions according to a preferred embodiment of the present invention;

FIG. 2 is a flow chart illustrating details of a method of receiving order information disclosed in FIG. 1;

FIG. 3 is a flow chart illustrating details of a method of processing orders disclosed in FIG. 1;

FIG. 4 is a flow chart illustrating details of a method of order verification disclosed in FIG. 1;

FIG. 5A is a flow chart illustrating details of a method of product pickup disclosed in FIG. 1;

FIG. 5B is a schematic diagram of an information communications system according to the preferred embodiment of the present invention;

FIG. 5C is part of a status of products table presented on a web page of an online store in accordance with the preferred embodiment of the present invention; and

FIG. 6 shows a web page of the online store for selecting a shop location for pickup of products.

### DETAILED DESCRIPTION OF THE INVENTION

The present invention provides a method for delivery of products purchased online. An online store is one component of an Internet website which a customer may electrically visit to purchase desired products. A supplier can receive the customer's order information from the online store via an electronic communications network. In a preferred embodiment of the present invention, a plurality of shops located in different areas are set up for pickup of products purchased online. The shops can exchange information with the online store via the network. A distribution center (DC) is set up for storing products and distributing them to each shop and directly to customers. Customers can purchase products from the online store, and designate one shop in a list of shops published by the online store for pickup of the products purchased.

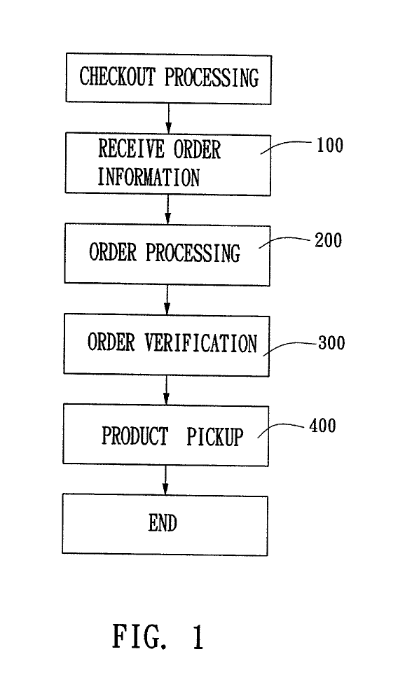

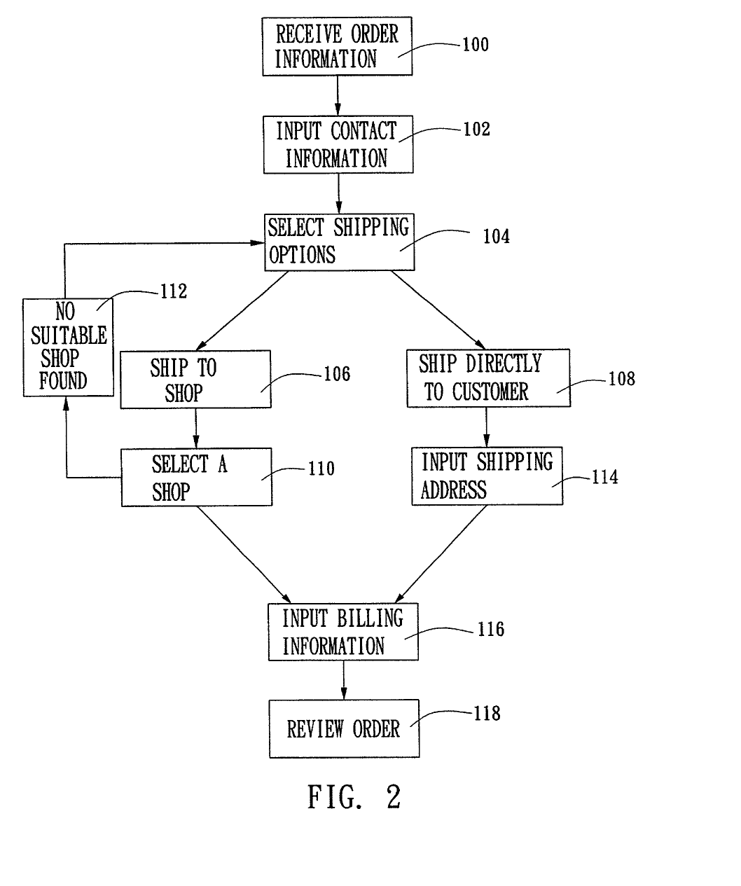

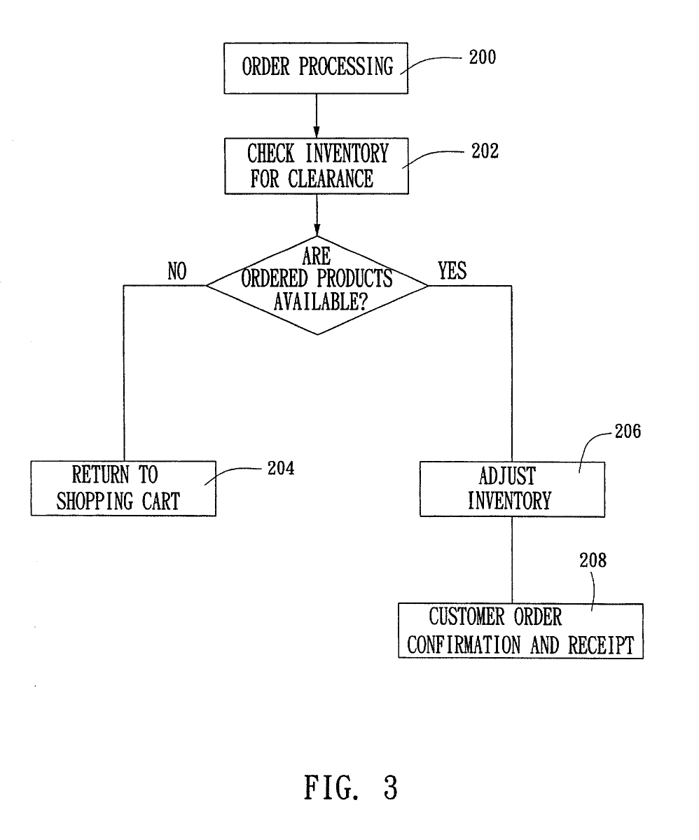

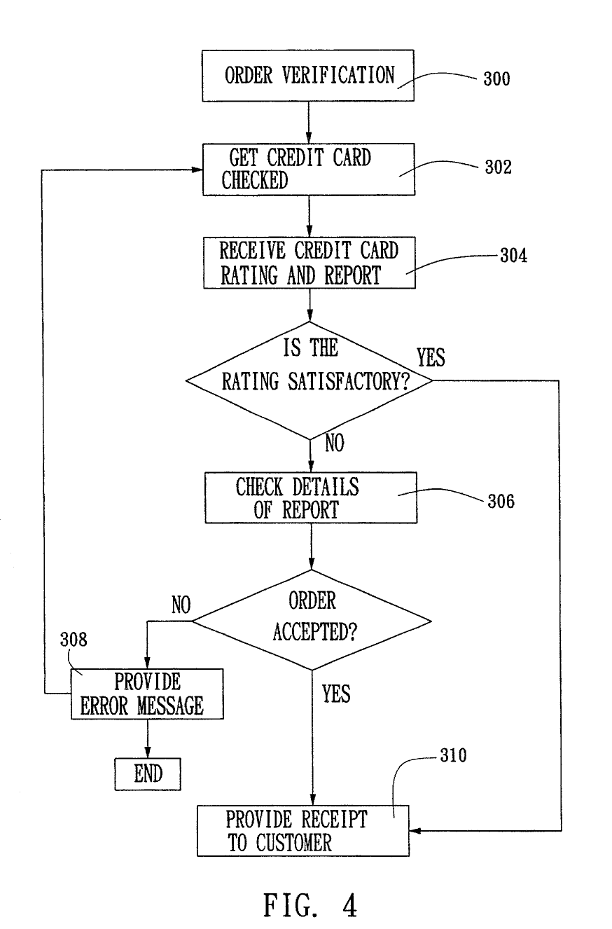

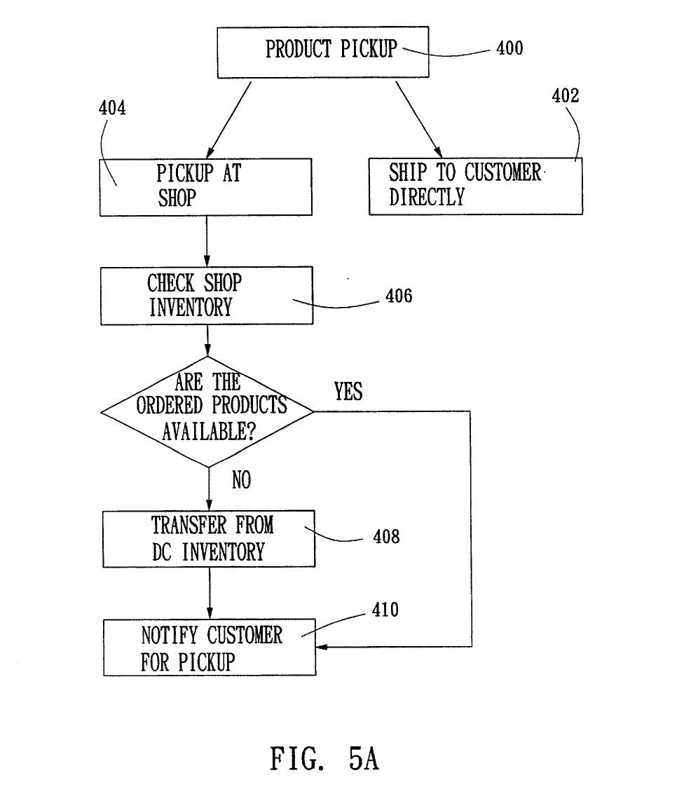

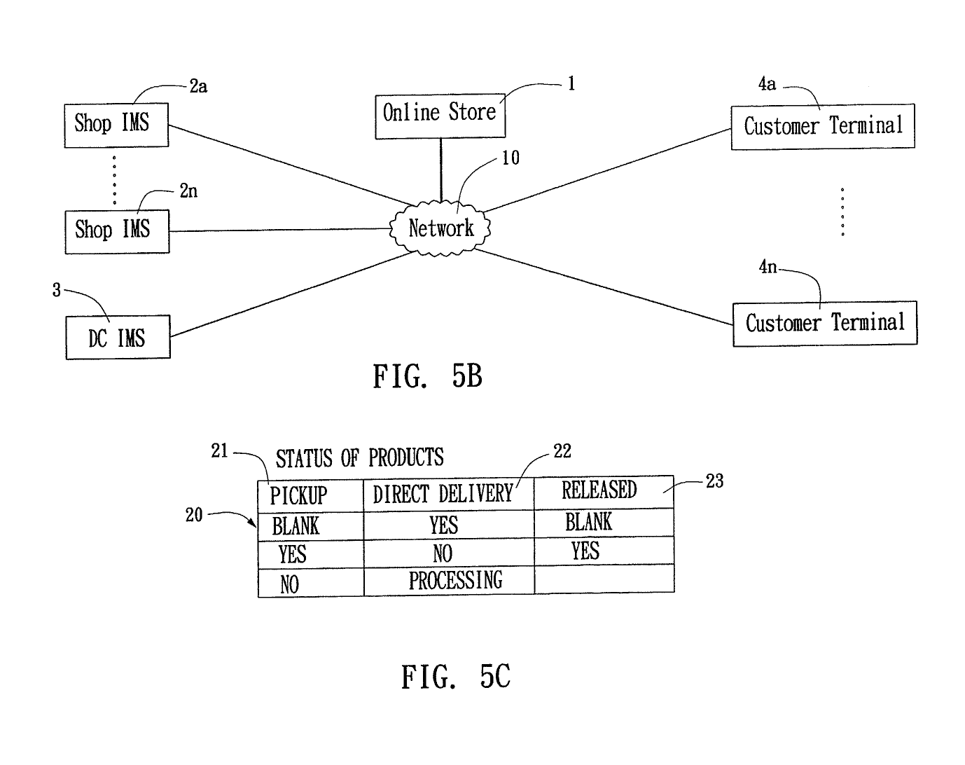

FIG. 1 is a flow chart illustrating a method of checkout processing of online transactions according to the preferred embodiment of the present invention. For conveniently describing the preferred embodiment, it will be assumed hereinafter that a customer purchases more than one product. In step 100, order information is received from a customer. The customer accesses the online store and selects required products from a list of products, according to well-known conventional means. The order information may include billing information, shipping information, and customer contact information. Step 100 is described in more detail below with reference to FIG. 2. In step 200, the customer's order is processed. Inventory in the distribution center is checked to confirm if the required products are available. Step 200 is described in more detail below with reference to FIG. 3. In step 300, the customer's order is verified. This may include checking terms of payment of the customer's order. An order with an unsatisfactory credit rating can be refused. Step 300 is described in more detail below with reference to FIG. 4. In step 400, the products are delivered to the place designated by the customer. The customer can either designate a pickup shop from an online list of shops, or input a shipping address according to shipping options provided online. The customer can also get information about status of products via the network. Status of products information includes availability of products in the designated shop and in the DC, and current shipping status. Step 400 is described in more detail below with reference to FIGS. 5A-5C.

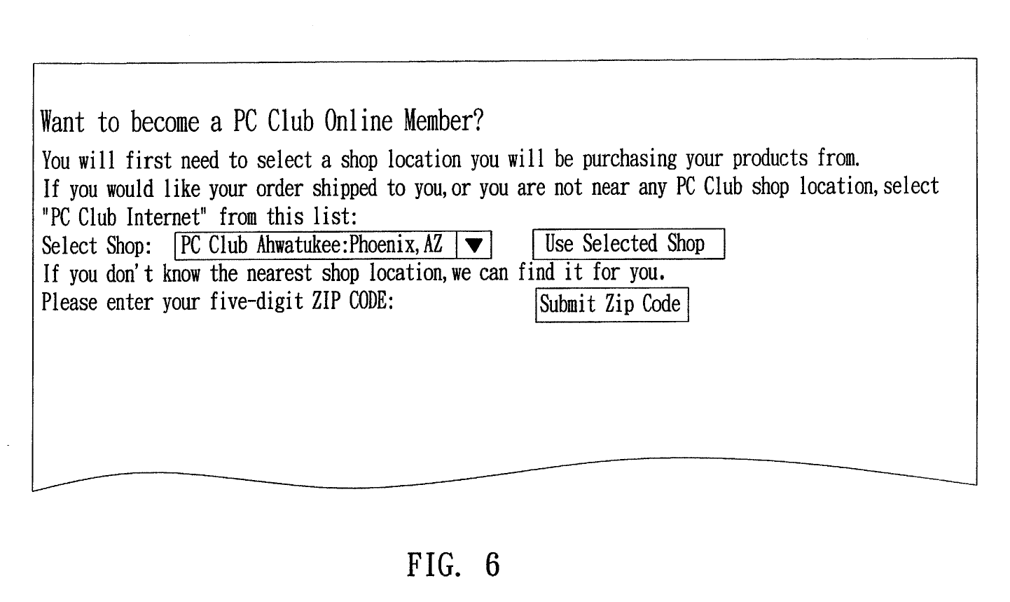

FIG. 2 shows the method of receiving order information 100 according to the preferred embodiment of the present invention. In step 102, a customer logs into the online store via the Internet. To become a member of the online store, the customer enters contact information by which the online products supplier can contact the customer. The contact information includes name, geographical address, e-mail address, and phone number. In step 104, the shipping options are provided for the customer to select a shipping address. The shipping address may be the address of one of several shops located in different areas. In addition, the customer can select a special option requiring the order to be directly shipped to the customer (see FIG. 6). In step 106, the customer has selected that the ordered products be shipped to a shop. Accordingly, in step 110, the customer selects a desired shop from a list of shops published by the online store. If the customer does not know which shop is nearest to him, he can input the zip code of his location. The online store then helps the customer ascertain the nearest shop, or suggests that the customer select direct shipping. In step 108, the customer has selected that his order be directly shipped to him. Accordingly, in step 112, the customer inputs details of his shipping address in a web page of the online store. The customer also inputs detailed contact information, such as daytime phone number and best time to call. After confirming the terms of shipping, in step 114, the customer inputs billing information for checkout. The billing information includes basic information about a credit card that the customer uses to pay for the products. Such information includes type of credit card, name of credit card holder, credit card account number, and credit card expiration date. In step 116, the customer reviews the order information provided thus far. This step allows the customer to modify data selected during the checkout process, including the products selected for purchase. Additionally, the customer may calculate online a total charge for all products selected.

FIG. 3 shows the method for processing orders 200 according to the preferred embodiment of the present invention. In step 202, inventory is checked to see if the ordered products are available. Such inventory may include the DC's inventory and the selected shop's inventory. If the ordered products are not available, then in step 204, the customer is notified accordingly and brought back to a shopping cart that shows data selected by the customer thus far. The customer can then modify the order. If the ordered products are available, then in step 206, the inventory is adjusted accordingly. This keeps the inventory up-to-date immediately upon completion of order verification 300. After completion of adjustment of inventory, in step 208, the customer's order is accepted. The online store then presents the next web page to the customer, where the customer can view and print out his order information. The information includes contents of the shopping cart, shipping and billing addresses, and an Internet sales order number.

FIG. 4 shows the method of order verification 300 according to the preferred embodiment of the present invention. In step 302, information on the customer and his credit card is electronically sent to a credit card authentication organization for checking. In step 304, the authentication organization determines a credit card rating and generates a credit card report, and sends the credit card rating and report to the online store. If the credit card rating is not satisfactory, then in step 306, the online store checks details of the report, and decides whether or not to accept the order. If the order is not accepted, then in step 308, an appropriate error message is provided to the customer. If the order is accepted or if the credit card rating is satisfactory, then in step 310, the customer is provided with an appropriate receipt. After completion of order verification, the ordered products are charged to the credit card by means of a conventional credit card transaction performed on a credit card network (not shown). Any conventional means of accessing the credit card network to conduct the credit card transaction is contemplated.

FIG. 5A shows the method of products pickup 400 according to the preferred embodiment of the present invention. If the customer has selected that the ordered products be shipped directly to him, then in step 402, the products are duly shipped to the customer directly. Any conventional means for delivering products to the customer is contemplated. In step 404, the customer has selected that the ordered products be picked up from a shop. Accordingly, in step 406, the shop inventory is checked to see whether the ordered products are available. If not available, then in step 408, the order products are transferred from the DC to the shop for pickup. In step 410, once the ordered products are available in the shop, the customer is notified by phone or e-mail accordingly. At the time the customer picks up the products from the shop, the shop's staff verify the customer's ID, check and confirm that the credit card presented by the customer is the same as the one used online, and get the customer to sign an appropriate invoice.

FIG. 5B is a schematic diagram of an information communications system according to the preferred embodiment of the present invention. An online store 1 is a virtual shop providing products and services information via an electronic communications network 10. Customers can visit and communicate with the online store 1 via a plurality of customer terminals 4a-4n connected to the network 10. A plurality of shop inventory management systems (IMSs) 2a-2n is connected with the online store 1 via the network 10. The shop IMSs 2a-2n are respectively located in different shops for managing inventory therein. A customer can ascertain the status of products of each shop by visiting the online store 1. A distribution center (DC) IMS 3 is also connected with the online store 1 via the network 10. After the customer has placed an order, the information communications system checks inventory to see if the ordered products are available. If the customer has selected the ordered products to be picked up from a shop, the designated shop's inventory is checked by visiting the shop IMS via the network 10. If the ordered products are not available in the designated shop, the DC inventory is then checked. Once the ordered products are determined to be available either at the designated shop or at the DC, the customer's order is accepted and an appropriate bill is charged by credit card. If the customer has selected the ordered products to be directly shipped to him, the information communications system automatically determines a shop that is nearest to the customer. This is done based on the shipping options provided by the customer, such as shipping address and zip code. If the ordered products are available in the determined shop, they are shipped to the customer from that shop. If the ordered products are not available in the determined shop, the ordered products are transferred from the DC to the determined shop. The ordered products are thereupon shipped to the customer.

FIG. 5C is part of a status of products table 20 presented on a web page of the online store 1. The table 20 displays the status of products ordered by the customer. The table 20 is created by the shop that has been designated for pickup of the ordered products, or by the shop that has been determined to be nearest to the customer. After the shop has been notified of the ordered products required for pickup or direct shipment, the shop creates the table 20. The table 20 comprises three columns: a “PICKUP” column 21, a “DIRECT DELIVERY” column 22, and a “RELEASED” column 23. The three columns respectively represent different processes and stages of delivery of the ordered products. In the “PICKUP” column 21, status of products for pickup from the shop is presented. “YES” means that the ordered products are available and ready for pickup. Pickup notification is duly sent to the customer. “NO” means that the ordered products are not available in the shop. The information communications system will then confirm whether the products are available in the DC. “BLANK” means that the shop has not input information on availability of the ordered products. If the column is left “BLANK”, it is assumed that the ordered products are not available in the shop. In the “DIRECT DELIVERY” column 22, a status of products for shipping directly to the customer is presented. “YES” means that the ordered products have been shipped to the customer's shipping address. “NO” means that the ordered products are unavailable through the online store 1. “PROCESSING” means that the customer's order is still being processed. The “RELEASED” column 23 shows whether the customer has picked up the ordered products. “YES” means that the ordered products have been picked up by the customer. “BLANK” means that the ordered products have not been picked up yet. The shop holds the products for a predetermined period, say two weeks, after notification to the customer for pickup. During this period the shop contacts the customer at predetermined regular intervals, say every 3-4 days, to remind the customer to pick up the products.

FIG. 6 shows a web page of the online store 1 for selecting a shop location for pickup of products. When a customer purchases products from the online store 1 for the first time, he is instructed to select a location for pickup of products. If the customer would like his order shipped directly to him, a special shipping option “PC Club Internet” is provided for the customer to input his shipping address. In addition, if the customer does not know the nearest shop location listed in the shipping options, he can submit his zip code to the online store 1. The online store 1 then gives the customer details of the nearest shop. Billing, shipping, and contact information is stored in a database of the online store 1. When the customer visits the online store 1 next time, his identity is checked according to his login name. Once the online store 1 has accepted the customer's identity, the customer can immediately proceed to purchase needed products. The customer need not input other information already provided previously.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A method for delivery of a product purchased online, the method being implemented in an online purchase environment which comprises an online store for receiving customers' orders, a plurality of shops located in different areas for pickup of products, and a distribution center for storing and distributing products to each shop and to customers, the method comprising the steps of:
receiving a customer's order from the online store via a communications network, the customer's order including purchase, billing, shipping and contact information;
providing a selection of shipping options for the customer, the shipping options including a first option of shipping to one of the shops and a second option of shipping directly to the customer;
checking inventory to ascertain whether the product ordered in the customer's order is available;
accepting the customer's order when the ordered product is available; and
shipping the ordered product according to the shipping option selected by the customer.

2. The method as claimed in claim 1, further comprising the step of: verifying the billing information to confirm that terms of payment provided by the customer are acceptable.

3. The method as claimed in claim 1, wherein the inventory includes shop inventory and distribution center inventory.

4. The method as claimed in claim 1, further comprising the step of: automatically adjusting the inventory of the ordered product according to the customer's order when the customer's order is accepted.

5. The method as claimed in claim 1, further comprising the step of: delivering the ordered product from the distribution center to a selected shop when such ordered product is not available in the selected shop.

6. The method as claimed in claim 1, further comprising the step of: providing an online web page for the customer to track subsequent processing of the ordered product.

7. The method as claimed in claim 1, further comprising the step of: receiving the customer's detailed shipping address when the customer has selected that the ordered product be shipped directly to the customer.

8. The method as claimed in claim 7, further comprising the step of: selecting a shop which is the nearest to the customer's detailed shipping address.

9. The method as claimed in claim 8, further comprising the step of: shipping the ordered product directly to the customer from the selected shop.

10. A method for delivery of a product purchased online, the method being implemented in an online purchase environment which comprises an online store for receiving customers' orders, a plurality of shops located in different areas for pickup of products, and a distribution center for storing and distributing products to each shop and to customers, the method comprising the steps of:
receiving a customer's order from the online store via a communications network, the customer's order including purchase, billing, shipping and contact information;
providing online a selection of shops from which the customer may select one shop for pickup of the ordered product;
checking inventory to ascertain whether the product ordered in the customer's order is available;
accepting the customer's order when the ordered product is available; and
shipping the ordered product to the shop selected by the customer for pickup.

11. The method as claimed in claim 10, further comprising the step of: verifying the billing information to confirm that terms of payment provided by the customer are acceptable.

12. The method as claimed in claim 10, wherein the inventory includes shop inventory and distribution center inventory.

13. The method as claimed in claim 10, further comprising the step of: automatically adjusting the inventory of the ordered product according to the customer's order when the customer's order is accepted.

14. The method as claimed in claim 10, further comprising the step of: delivering the ordered product from the distribution center to the shop selected by the customer when such ordered product is not available in the selected shop.

15. The method as claimed in claim 10, further comprising the step of: providing an online web page for the customer to track subsequent processing of the ordered product.

16. A method of implementing an online order comprising the steps of:
providing an online store for receiving a customer's order, a plurality of shops located at different area for pick-up of products, and a distribution center for storing said products and distributing said products to the corresponding stores or to designated places by the customers directly;
receiving an order of a customer from the online store via a communication network including pick-up or direct delivery options;
helping the customer find the properly located shop for pick-up if pick-up at the shop is preferably selected by the customer while he does not know which shop is available; and
delivering the ordered products either to the selected shops for pick-up or directly to the designated places by the customers.
